(19) United States
(12) Patent Application Publication
(10) Pub. No.: US 2026/0061382 A1
(43) Pub. Date: Mar. 5, 2026

(54) HIGH-TEMPERATURE AND HIGH-PRESSURE PREPARATION METHOD FOR HEXAGONAL DIAMOND

(71) Applicant: JILIN UNIVERSITY, Changchun City (CN)

(72) Inventors: Mingguang YAO, Changchun City (CN); Jiajun DONG, Changchun City (CN); Desi CHEN, Changchun City (CN)

(21) Appl. No.: 19/025,357

(22) Filed: Jan. 16, 2025

(30) Foreign Application Priority Data
Aug. 27, 2024 (CN) 202411183506.0

(51) Int. Cl. B01J 3/06

(52) U.S. Cl. CPC B01J 3/062; B01J 3/065; B01J 2203/061; B01J 2203/0655

(57) ABSTRACT

The present disclosure discloses a high-temperature and high-pressure preparation method for hexagonal diamond, which belongs to the field of superhard material synthesis technology. The method comprises making high-purity graphite into a precursor, assembling the synthesis block, and then subjecting it to heating, pressurizing, temperature holding, and pressure holding processes to obtain hexagonal diamond. The preparation method for hexagonal diamond according to the present disclosure allows high-purity graphite to achieve higher pressure along the c-axis direction, further promoting the phase transition of graphite. In addition, the temperature field where the precursor is located has a certain temperature gradient, which facilitates the transformation of high-purity graphite into hexagonal diamond and achieves a better conversion rate of hexagonal diamond.

### CROSS-REFERENCE TO RELATED APPLICATIONS

The present application claims the priority to Chinese Patent Application No. 202411183506.0, filed with the China National Intellectual Property Administration on Aug. 27, 2024, and entitled “A HIGH-TEMPERATURE AND HIGH-PRESSURE PREPARATION METHOD FOR HEXAGONAL DIAMOND”, which is incorporated herein by reference in its entirety.

### TECHNICAL FIELD

The present disclosure relates to the field of superhard material synthesis, and more particularly, relates to a preparation method for hexagonal diamond.

### BACKGROUND

Diamond is known as the hardest material found in nature. In the continuous development and innovation of modern industry, superhard materials, with diamond at the forefront, have become known as the “sharpest industrial teeth” and are essential “hard support”for the transformation and upgrading of the manufacturing industry.

Before 1967, all discovered and manufactured diamonds were of a cubic structure. However, in 1967, a hexagonal diamond, also known as lonsdaleite, was discovered in the Barringer Meteor Crater in Arizona, USA. This type of diamond has bonding characteristics similar to cubic diamonds but is much harder. As a result, it has sparked significant interest both in practical applications and fundamental scientific research. Theoretical calculations show that hexagonal diamond is 58% harder than cubic diamond, which has stimulated a great deal of synthetic work.

A research team from Osaka University in Japan conducted high-temperature and high-pressure experiments on single-crystal graphite with larger grain sizes. They carried out synthesis experiments under pressure and temperature conditions of 20 GPa and 800° C. to 1800 ° C., respectively, and found the presence of hexagonal diamond in the samples, although its content was generally very low. The sample with the highest hexagonal structure content was synthesized at 20 GPa and 1200° C. X-ray diffraction analysis showed that the content of hexagonal diamond in this sample was only fifty percent, with the rest being graphite and cubic diamond structures. DOI: 10.1143/JJAP.42.1694

An American research team characterized the microstructure of the meteorite in which hexagonal diamond was found using transmission electron microscopy. They concluded that hexagonal diamond is only a stacking fault or twinning boundary structure of cubic diamond and cannot exist independently. Additionally, they verified previous experiments by treating graphite at 19 GPa and 2273 K and analyzing the structure of the obtained samples. They did not find hexagonal diamond existing independently in the samples after pressure release. https://doi. org/10.1038/ncomms6447

French and Japanese research teams conducted high-temperature and high-pressure experiments using polycrystalline graphite, highly oriented pyrolytic graphite, carbon black, quasi-amorphous carbon, and thermally treated carbon black as precursors. They carried out experiments under conditions of 15 GPa and 1500° C. to 1900° C. and found the presence of hexagonal diamond structures in the samples with polycrystalline graphite and highly oriented pyrolytic graphite as precursors, whereas no hexagonal diamond was found in other precursors. https://doi. org/10.1016/j. carbon.2006.10.005

Despite significant efforts in the artificial synthesis of hexagonal diamond structures, the purity of the hexagonal diamond obtained remains very low. Typically, a very high proportion of cubic diamond is mixed into the main product, leading some to question the existence of hexagonal diamond, and to believe that hexagonal diamond exists in the form of stacking faults or twins within cubic diamond rather than as an independent structure. One reason for this is that cubic diamond is more stable and easier to form under high-pressure and high-temperature conditions, which is why cubic diamond always dominates or coexists with hexagonal diamond in synthetic samples. Therefore, there is an urgent need for a new artificial preparation method to address this long-standing challenge and synthesize pure hexagonal diamond.

### SUMMARY OF THE INVENTION

The technical problem to be solved by the present disclosure is to provide a preparation method for hexagonal diamond with a high conversion rate and high purity.

To address the above technical problem, the present disclosure provides a high-temperature and high-pressure preparation method for hexagonal diamond, comprising:
a) preparation of a precursor including: selecting high-purity graphite, processing the selected high-purity graphite into a cylindrical shape, cleaning and then vacuum drying the processed high-purity graphite, to obtain the precursor;
b) assembly of a synthesis block including: placing a cylindrical diamond plug on an upper surface of the precursor, with a lower surface of the diamond plug coinciding with the upper surface of the precursor; tightly enclosing outer vertical sidewalls of the precursor and the diamond plug with an insulating tube which insulates the precursor and the diamond plug from a heating tube, to obtain a first assembly of the precursor, the insulating tube, and the diamond plug; placing the first assembly vertically in a chamber of a high-temperature and high-pressure apparatus, with the precursor positioned at a center of the chamber; placing a first cylindrical zirconia plug on an upper surface of the first assembly, with a lower surface of the zirconia plug coinciding with the upper surface of the first assembly; placing a cylindrical alumina plug on a lower surface of the first assembly, with an upper surface of the alumina plug coinciding with the lower surface of the first assembly; placing a second cylindrical zirconia plug on a lower surface of the alumina plug, with an upper surface of the second zirconia plug coinciding with the lower surface of the alumina plug; tightly enclosing outer vertical sidewalls of a second assembly of the precursor, the insulating tube, the diamond plug, the first and second zirconia plugs, and the alumina plug with the heating tube for subsequent indirect heating, wherein a temperature of the heating tube is measured by a thermocouple; and tightly enclosing an outer vertical sidewall of the heating tube with a zirconia tube, with an outer vertical sidewall of the zirconia tube in close contact with inner vertical sidewalls of a magnesium oxide octahedron of the high-temperature and high-pressure apparatus; and
c) synthesis process including: increasing a pressure in the chamber to a first pressure at a rate of 1 GPa/h, then increasing a temperature in the chamber to a first temperature at a rate of 100° C./min; maintaining the first temperature for a certain period, then rapidly quenching to room temperature; maintaining the first pressure for a period, then reducing the pressure to zero at a rate of 1 GPa/h; after pressure release, removing a product from the chamber; and removing residual substances on a surface of the product to obtain a final product of hexagonal diamond.

In an embodiment, the high-purity graphite has a purity of 99.99% or greater and has AB stacking.

In an embodiment, graphite layers of the precursor remain horizontal, with a c-axis of graphite of the precursor always oriented vertically upward.

In an embodiment, the room temperature is between 18° C. and 32° C.

In an embodiment, the first pressure is 30 Gpa.

In an embodiment, the first temperature is maintained for a period between 15 minutes and 20 minutes.

In an embodiment, the first pressure is maintained for a period between 5 minutes and 10 minutes.

In an embodiment, the first temperature is between 1400° C. and 1500° C.

In an embodiment, the first temperature is 1400° C.

The present disclosure provides the following beneficial effects through the above scheme:
By adding a diamond plug and an alumina plug, which are harder than zirconia, on both sides of the precursor with these plugs directly contacting the sample, the pressure environment in the precursor region is significantly improved. Additionally, since the graphite layers of the precursor remain horizontal and the c-axis of graphite is always oriented vertically upward, the graphite can achieve higher pressure along the c-axis, further promoting the phase transition of graphite.

With the diamond plug and the alumina plug directly contacting both sides of the precursor, additional pressure is applied to the precursor, and since they have different thermal conductivities, a temperature gradient is generated across the entire temperature field where the precursor is located during heating. This temperature gradient facilitates the transformation of graphite into hexagonal diamond and results in a higher conversion rate compared to using only diamond plugs.

The hexagonal diamond synthesized by this method has extremely high hardness, with a Vickers hardness converging to 155 GPa under a 1 kg load, far exceeding that of cubic diamond. The high-temperature and high-pressure method for preparing hexagonal diamond according to the present disclosure provides strong guidance for the production and application of hexagonal diamond.

### BRIEF DESCRIPTION OF THE DRAWINGS

The present disclosure will be further described in conjunction with the accompanying drawings and specific embodiments:

FIG. 1 is a schematic diagram of the octahedral assembly of the high-temperature high-pressure apparatus in Example 1, Example 2, Comparative Example 1, Comparative Example 2, and Comparative Example 3.

FIG. 2 shows the 325 nm Raman spectra of the products obtained in Examples 1 and 2.

FIG. 3 shows the XRD patterns of two orientations of the products obtained in Examples 1 and 2.

FIG. 4 shows the high-resolution transmission electron microscopy (HRTEM) images of the products obtained in Examples 1 and 2.

FIG. 5 shows the Vickers hardness of the products obtained in Examples 1 and 2.

FIG. 6 shows the XRD spectra of the products obtained in Example 1 and Comparative Example 4.

FIG. 7 shows the XRD spectra of the products obtained in Example 1 and Comparative Examples 1, 2, and 3.

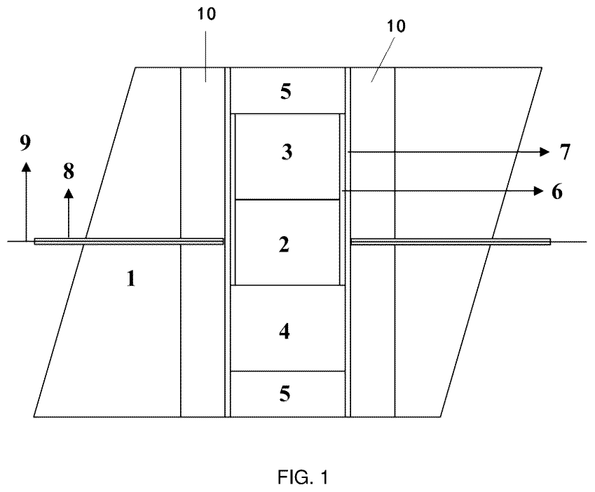

### DETAILED DESCRIPTION

To make the objectives, technical solutions, and advantages of the present disclosure clearer, a further detailed description of the high-temperature and high-pressure preparation method for hexagonal diamond is provided below in conjunction with the accompanying drawings. It should be understood that the specific embodiments described here are only for explaining the present disclosure and do not constitute a limitation of the invention.

### Example 1

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor 2 for assembly.

### 2. Assembly of the Synthesis Block

A cylindrical diamond plug 3 was placed on the upper surface of the precursor 2, with the lower surface of the diamond plug 3 coinciding with the upper surface of the precursor 2. The outer vertical sidewalls of the precursor 2 and the diamond plug 3 were tightly enclosed with a magnesium oxide tube 6 which insulates the precursor 2 and the diamond plug 3 from a rhenium heating tube 7 to be discussed later, to obtain an assembly of the precursor 2, the magnesium oxide tube 6, and the diamond plug 3. The assembly was vertically placed in a chamber of a high-temperature and high-pressure apparatus, with the precursor 2 located at the center of the chamber. A cylindrical zirconia plug 5 was placed on the upper surface of this assembly, with the lower surface of the zirconia plug 5 coinciding with the upper surface of the assembly. A cylindrical alumina plug 4 was placed on the lower surface of the assembly, with the upper surface of the alumina plug 4 coinciding with the lower surface of the assembly. Another cylindrical zirconia plug 5 was placed on the lower surface of the alumina plug 4, with the upper surface of the zirconia plug 5 coinciding with the lower surface of the alumina plug 4. The vertical sidewalls of an assembly of the precursor 2, the magnesium oxide tube 6, the diamond plug 3, the two zirconia plugs 5, and the alumina plug 4 were tightly enclosed with a thin rhenium heating tube 7 for indirect heating. The temperature of the rhenium heating tube 7 was measured using a tungsten-rhenium thermocouple 9, which was tightly enclosed with a copper tube protective sleeve 8 on the outside. The outer vertical sidewall of the rhenium heating tube 7 was tightly enclosed with a zirconia tube 10, with the outer vertical sidewall of the zirconia tube 10 in close contact with the inner vertical surfaces of the magnesium oxide octahedron 1.

### 3. Synthesis Process

The pressure was increased at a rate of 1 GPa/h to 30 GPa, and the temperature was then increased at a rate of 100° C./min to 1400° C. The temperature was maintained for 15 minutes, and then the sample was rapidly quenched to 25° C. After maintaining the pressure for 10 minutes, the pressure was reduced to zero at a rate of 1 GPa/h. After pressure release, the product was removed, and any residual material on the surface of the product was removed to obtain the final product.

### Example 2

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor 2 for assembly.

### 2. Assembly of the Synthesis Block

A cylindrical diamond plug 3 was placed on the upper surface of the precursor 2, with the lower surface of the diamond plug 3 coinciding with the upper surface of the precursor 2. The outer vertical sidewalls of the precursor 2 and the diamond plug 3 were tightly enclosed with a magnesium oxide tube 6 which insulates the precursor 2 and the diamond plug 3 from a rhenium heating tube 7 to be discussed later, to obtain an assembly of the precursor 2, the magnesium oxide tube 6, and the diamond plug 3. The assembly was vertically placed in a chamber of a high-temperature and high-pressure apparatus, with the precursor 2 located at the center of the chamber. A cylindrical zirconia plug 5 was placed on the upper surface of this assembly, with the lower surface of the zirconia plug 5 coinciding with the upper surface of the assembly. A cylindrical alumina plug 4 was placed on the lower surface of the assembly, with the upper surface of the alumina plug 4 coinciding with the lower surface of the assembly. Another cylindrical zirconia plug 5 was placed on the lower surface of the alumina plug 4, with the upper surface of the zirconia plug 5 coinciding with the lower surface of the alumina plug 4. The vertical sidewalls of an assembly of the precursor 2, the magnesium oxide tube 6, the diamond plug 3, the two zirconia plugs 5, and the alumina plug 4 were tightly enclosed with a thin rhenium heating tube 7 for indirect heating. The temperature of the rhenium heating tube 7 was measured using a tungsten-rhenium thermocouple 9, which was tightly enclosed with a copper tube protective sleeve 8 on the outside. The outer vertical sidewall of the rhenium heating tube 7 was tightly enclosed with a zirconia tube 10, with the outer vertical sidewall of the zirconia tube 10 in close contact with the inner vertical surfaces of the magnesium oxide octahedron 1.

### 3. Synthesis Process

The pressure was increased at a rate of 1 GPa/h to 30 GPa, and the temperature was then increased at a rate of 100° C./min to 1400° C. The temperature was maintained for 20 minutes, and then the sample was rapidly quenched to 25° C. After maintaining the pressure for 5 minutes, the pressure was reduced to zero at a rate of 1 GPa/h. After pressure release, the product was removed, and any residual material on the surface of the product was removed to obtain the final product.

### Comparative Example 1

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor 2 for assembly.

### 2. Assembly of the Synthesis Block

A cylindrical diamond plug 3 was placed on the upper surface of the precursor 2, with the lower surface of the diamond plug 3 coinciding with the upper surface of the precursor 2. The outer vertical sidewalls of the precursor 2 and the diamond plug 3 were tightly enclosed with a magnesium oxide tube 6 which insulates the precursor 2 and the diamond plug 3 from a rhenium heating tube 7 to be discussed later, to obtain an assembly of the precursor 2, the magnesium oxide tube 6, and the diamond plug 3. The assembly was vertically placed in a chamber of a high-temperature and high-pressure apparatus, with the precursor 2 located at the center of the chamber. A cylindrical zirconia plug 5 was placed on the upper surface of this assembly, with the lower surface of the zirconia plug 5 coinciding with the upper surface of the assembly. A cylindrical alumina plug 4 was placed on the lower surface of the assembly, with the upper surface of the alumina plug 4 coinciding with the lower surface of the assembly. Another cylindrical zirconia plug 5 was placed on the lower surface of the alumina plug 4, with the upper surface of the zirconia plug 5 coinciding with the lower surface of the alumina plug 4. The vertical sidewalls of an assembly of the precursor 2, the magnesium oxide tube 6, the diamond plug 3, the two zirconia plugs 5, and the alumina plug 4 were tightly enclosed with a thin rhenium heating tube 7 for indirect heating. The temperature of the rhenium heating tube 7 was measured using a tungsten-rhenium thermocouple 9, which was tightly enclosed with a copper tube protective sleeve 8 on the outside. The outer vertical sidewall of the rhenium heating tube 7 was tightly enclosed with a zirconia tube 10, with the outer vertical sidewall of the zirconia tube 10 in close contact with the inner vertical surfaces of the magnesium oxide octahedron 1.

### 3. Synthesis Process

The pressure was increased at a rate of 1 GPa/h to 30 GPa, and the temperature was then increased at a rate of 100° C./min to 1200° C. The temperature was maintained for 15 minutes, and then the sample was rapidly quenched to 25° C. After maintaining the pressure for 10 minutes, the pressure was reduced to zero at a rate of 1 GPa/h. After pressure release, the product was removed, and any residual material on the surface of the product was removed to obtain the final product.

### Comparative Example 2

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor 2 for assembly.

### 2. Assembly of the Synthesis Block

A cylindrical diamond plug 3 was placed on the upper surface of the precursor 2, with the lower surface of the diamond plug 3 coinciding with the upper surface of the precursor 2. The outer vertical sidewalls of the precursor 2 and the diamond plug 3 were tightly enclosed with a magnesium oxide tube 6 which insulates the precursor 2 and the diamond plug 3 from a rhenium heating tube 7 to be discussed later, to obtain an assembly of the precursor 2, the magnesium oxide tube 6, and the diamond plug 3. The assembly was vertically placed in a chamber of a high-temperature and high-pressure apparatus, with the precursor 2 located at the center of the chamber. A cylindrical zirconia plug 5 was placed on the upper surface of this assembly, with the lower surface of the zirconia plug 5 coinciding with the upper surface of the assembly. A cylindrical alumina plug 4 was placed on the lower surface of the assembly, with the upper surface of the alumina plug 4 coinciding with the lower surface of the assembly. Another cylindrical zirconia plug 5 was placed on the lower surface of the alumina plug 4, with the upper surface of the zirconia plug 5 coinciding with the lower surface of the alumina plug 4. The vertical sidewalls of an assembly of the precursor 2, the magnesium oxide tube 6, the diamond plug 3, the two zirconia plugs 5, and the alumina plug 4 were tightly enclosed with a thin rhenium heating tube 7 for indirect heating. The temperature of the rhenium heating tube 7 was measured using a tungsten-rhenium thermocouple 9, which was tightly enclosed with a copper tube protective sleeve 8 on the outside. The outer vertical sidewall of the rhenium heating tube 7 was tightly enclosed with a zirconia tube 10, with the outer vertical sidewall of the zirconia tube 10 in close contact with the inner vertical surfaces of the magnesium oxide octahedron 1.

### 3. Synthesis Process

The pressure was increased at a rate of 1 GPa/h to 30 GPa, and the temperature was then increased at a rate of 100° C./min to 1500° C. The temperature was maintained for 15 minutes, and then the sample was rapidly quenched to 25° C. After maintaining the pressure for 10 minutes, the pressure was reduced to zero at a rate of 1 GPa/h. After pressure release, the product was removed, and any residual material on the surface of the product was removed to obtain the final product.

### Comparative Example 3

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor 2 for assembly.

### 2. Assembly of the Synthesis Block

A cylindrical diamond plug 3 was placed on the upper surface of the precursor 2, with the lower surface of the diamond plug 3 coinciding with the upper surface of the precursor 2. The outer vertical sidewalls of the precursor 2 and the diamond plug 3 were tightly enclosed with a magnesium oxide tube 6 which insulates the precursor 2 and the diamond plug 3 from a rhenium heating tube 7 to be discussed later, to obtain an assembly of the precursor 2, the magnesium oxide tube 6, and the diamond plug 3. The assembly was vertically placed in a chamber of a high-temperature and high-pressure apparatus, with the precursor 2 located at the center of the chamber. A cylindrical zirconia plug 5 was placed on the upper surface of this assembly, with the lower surface of the zirconia plug 5 coinciding with the upper surface of the assembly. A cylindrical alumina plug 4 was placed on the lower surface of the assembly, with the upper surface of the alumina plug 4 coinciding with the lower surface of the assembly. Another cylindrical zirconia plug 5 was placed on the lower surface of the alumina plug 4, with the upper surface of the zirconia plug 5 coinciding with the lower surface of the alumina plug 4. The vertical sidewalls of an assembly of the precursor 2, the magnesium oxide tube 6, the diamond plug 3, the two zirconia plugs 5, and the alumina plug 4 were tightly enclosed with a thin rhenium heating tube 7 for indirect heating. The temperature of the rhenium heating tube 7 was measured using a tungsten-rhenium thermocouple 9, which was tightly enclosed with a copper tube protective sleeve 8 on the outside. The outer vertical sidewall of the rhenium heating tube 7 was tightly enclosed with a zirconia tube 10, with the outer vertical sidewall of the zirconia tube 10 in close contact with the inner vertical surfaces of the magnesium oxide octahedron 1.

### 3. Synthesis Process

The pressure was increased at a rate of 1 GPa/h to 30 GPa, and the temperature was then increased at a rate of 100° C./min to 1700° C. The temperature was maintained for 15 minutes, and then the sample was rapidly quenched to 25° C. After maintaining the pressure for 10 minutes, the pressure was reduced to zero at a rate of 1 GPa/h. After pressure release, the product was removed, and any residual material on the surface of the product was removed to obtain the final product.

### Comparative Example 4

### 1. Preparation of Precursor

A-grade highly oriented pyrolytic graphite having a purity of 99.99% or greater and AB stacking was processed into a cylinder with a diameter of 2 mm and a height of 2 mm. The layers of the processed A-grade highly oriented pyrolytic graphite remained horizontal, with the c-axis always oriented vertically upward. The processed A-grade highly oriented pyrolytic graphite was placed in anhydrous ethanol and subjected to ultrasonic cleaning to remove edge debris, then placed in a drying oven and vacuum-dried at 120° C. for 2 hours to obtain the precursor for assembly.

### 2. Assembly of the Synthesis Block

A cylindrical alumina plug was placed on the upper surface of the precursor, with the lower surface of the alumina plug coinciding with the upper surface of the precursor. The outer vertical sidewalls of the precursor and the alumina plug were tightly enclosed with a magnesium oxide tube which insulates the precursor and the alumina plug from a rhenium heating tube to be discussed later, to obtain an assembly of the precursor, the magnesium oxide tube, and the alumina plug. The assembly was vertically placed in a chamber of a high-temperature and high-pressure apparatus, with the precursor located at the center of the chamber. A cylindrical zirconia plug was placed on the upper surface of this assembly, with the lower surface of the zirconia plug coinciding with the upper surface of the assembly. Another cylindrical alumina plug was placed on the lower surface of the assembly, with the upper surface of the alumina plug coinciding with the lower surface of the assembly. Another cylindrical zirconia plug was placed on the lower surface of the alumina plug, with the upper surface of the zirconia plug coinciding with the lower surface of the alumina plug. The vertical sidewalls of an assembly of the precursor, the magnesium oxide tube, the two alumina plugs, and the two zirconia plugs were tightly enclosed with a thin rhenium heating tube for indirect heating. The temperature of the rhenium heating tube was measured using a tungsten-rhenium thermocouple, which was tightly enclosed with a copper tube protective sleeve on the outside. The outer vertical sidewalls of the rhenium heating tube were tightly enclosed with a zirconia tube, with the outer vertical sidewalls of the zirconia tube in close contact with the inner vertical surfaces of the magnesium oxide octahedron.

### 3. Synthesis Process

The pressure was increased at a rate of 1 GPa/h to 30 GPa, and the temperature was then increased at a rate of 100° C./min to 1400° C. The temperature was maintained for 15 minutes, and then the sample was rapidly quenched to 25° C. After maintaining the pressure for 10 minutes, the pressure was reduced to zero at a rate of 1 GPa/h. After pressure release, the product was removed, and any residual material on the surface of the product was removed to obtain the final product.

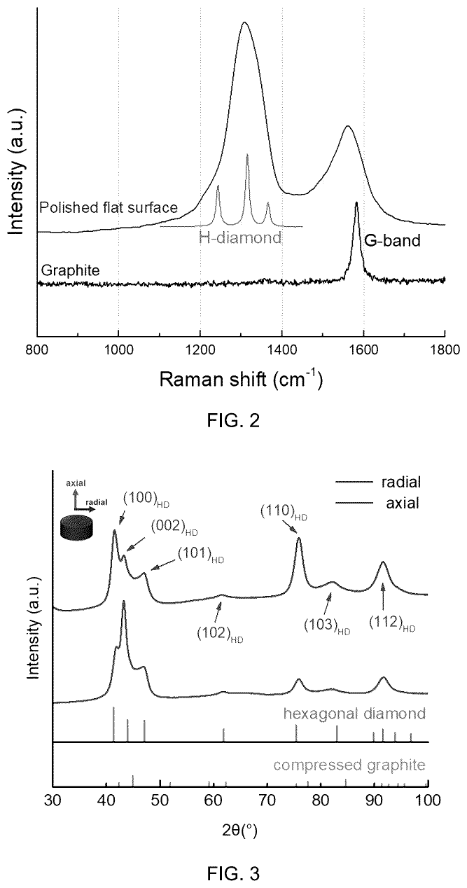

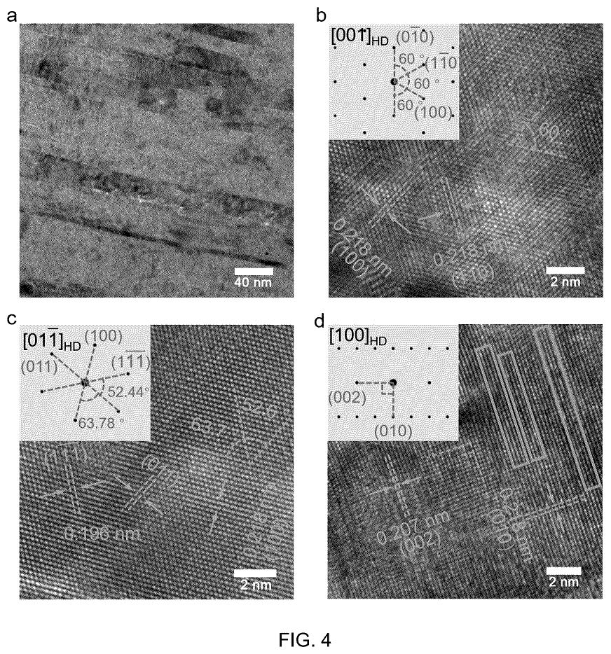

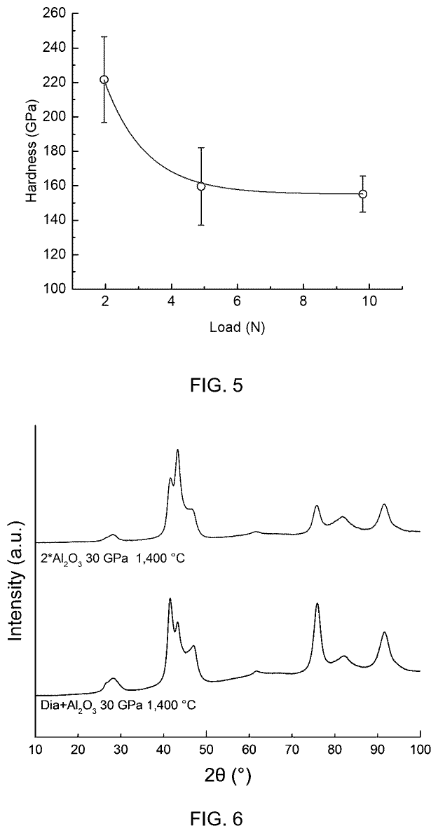

The products from the Examples and Comparative Examples underwent polishing on their upper and lower surfaces as well as sidewalls to facilitate Vickers hardness and X-ray diffraction spectra (XRD) testing. The products obtained from Examples 1 and 2 have Vickers hardness values of 155 GPa under a 1 kg load, as shown in FIG. 5, with their XRD patterns consistent with the theoretical XRD of hexagonal diamond. Additionally, the products obtained from Examples 1 and 2 were processed using a focused ion beam to produce transmission samples, as shown in FIGS. 2, 3, and 4. Comprehensive characterization of the transmission samples' structure was performed using transmission electron microscopy, further confirming that the products obtained in Examples 1 and 2 are hexagonal diamond blocks. The refined content in the XRD spectra of FIG. 3 indicates that the hexagonal diamond content is up to 95% or more.

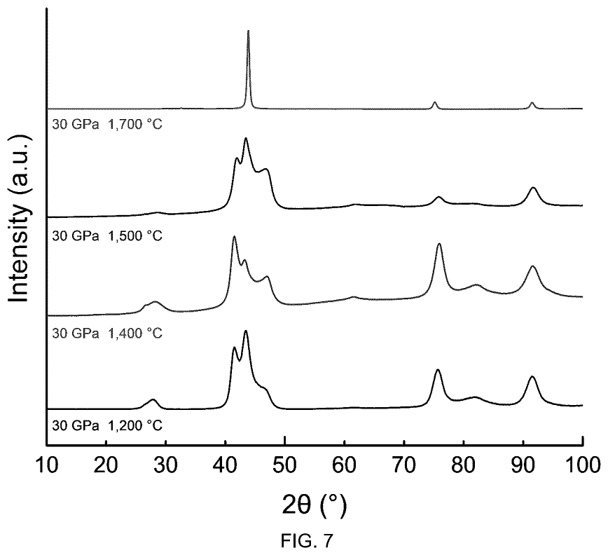

Comparing Example 1 with Comparative Example 4, as shown in FIG. 6, and comparing Example 1 with Comparative Examples 1, 2, and 3, as shown in FIG. 7, demonstrates that the product obtained using the high-temperature and high-pressure preparation method for hexagonal diamond according to the present disclosure has the highest purity of hexagonal diamond.

### LIST OF REFERENCE SIGNS

1—Magnesium oxide octahedron
2—Precursor
3—Diamond plug
4—Alumina plug
5—Zirconia plug
6—Magnesium oxide tube
7—Rhenium heating tube
8—Copper tube protective sleeve
9—Tungsten-rhenium thermocouple
10—Zirconia tube.

What is claimed is:

1. A high-temperature and high-pressure preparation method for hexagonal diamond, comprising:
a) preparation of a precursor including: selecting high-purity graphite, processing the selected high-purity graphite into a cylindrical shape, cleaning and then vacuum drying the processed high-purity graphite, to obtain the precursor;
b) assembly of a synthesis block including: placing a cylindrical diamond plug on an upper surface of the precursor, with a lower surface of the diamond plug coinciding with the upper surface of the precursor; tightly enclosing outer vertical sidewalls of the precursor and the diamond plug with an insulating tube which insulates the precursor and the diamond plug from a heating tube, to obtain a first assembly of the precursor, the insulating tube, and the diamond plug; placing the first assembly vertically in a chamber of a high-temperature and high-pressure apparatus, with the precursor positioned at a center of the chamber; placing a first cylindrical zirconia plug on an upper surface of the first assembly, with a lower surface of the zirconia plug coinciding with the upper surface of the first assembly; placing a cylindrical alumina plug on a lower surface of the first assembly, with an upper surface of the alumina plug coinciding with the lower surface of the first assembly; placing a second cylindrical zirconia plug on a lower surface of the alumina plug, with an upper surface of the second zirconia plug coinciding with the lower surface of the alumina plug; tightly enclosing outer vertical sidewalls of a second assembly of the precursor, the insulating tube, the diamond plug, the first and second zirconia plugs, and the alumina plug with the heating tube for subsequent indirect heating, wherein a temperature of the heating tube is measured by a thermocouple; and tightly enclosing an outer vertical sidewall of the heating tube with a zirconia tube, with an outer vertical sidewall of the zirconia tube in close contact with inner vertical sidewalls of a magnesium oxide octahedron of the high-temperature and high-pressure apparatus; and
c) synthesis process including: increasing a pressure in the chamber to a first pressure at a rate of 1 GPa/h, then increasing a temperature in the chamber to a first temperature at a rate of 100° C./min; maintaining the first temperature for a certain period, then rapidly quenching to room temperature; maintaining the first pressure for a period, then reducing the pressure to zero at a rate of 1 GPa/h; after pressure release, removing a product from the chamber; and removing residual substances on a surface of the product to obtain a final product of hexagonal diamond.

2. The method of claim 1, wherein the high-purity graphite has a purity of 99.99% or greater and has AB stacking.

3. The method of claim 1, wherein graphite layers of the precursor remain horizontal, with a c-axis of graphite of the precursor always oriented vertically upward.

4. The method of claim 1, wherein the first pressure is 30 GPa.

5. The method of claim 1, wherein the first temperature is 1400° C.

6. The method of claim 1, wherein the first temperature is maintained for a period between 15 minutes and 20 minutes.

7. The method of claim 1, wherein the first pressure is maintained for a period between 5 minutes and 10 minutes.
